(19) United States
(12) Patent Application Publication
(10) Pub. No.: US 2008/0216660 A1
(43) Pub. Date: Sep. 11, 2008

(54) Electrostatic Precipitator with Replaceable Collecting Electrode

(76) Inventors: Frank Mendel, Drensteinfurt (DE); Stephan Alborn, Senden (DE)

Correspondence Address: BOHAN MATHERS, PO BOX 17707, PORTLAND, ME, 04112-8707, US

(21) Appl. No.: 11/994,693

(22) PCT Filed: Jun. 22, 2006
(86) PCT No.: PCT/DE2006/001057

§ 371 Date: Jan. 4, 2008

(30) Foreign Application Priority Data
Jul. 5, 2005 (DE) 20 2005 010 532.5

(51) Int. Cl. B03C 3/40; F01M 13/00

(52) U.S. Cl. 96/88; 96/83; 96/94; 123/41.86; 96/39

(57) ABSTRACT

A collecting electrode for an electrostatic precipitator in an internal combustion engine, which is easily replaceable during routine maintenance.

### BACKGROUND INFORMATION

1. Field of the Invention

The invention relates to a collecting electrode.

2. Description of the Prior Art

Collecting electrodes are provided in electrostatic precipitators, for example, in an electrostatic precipitator for precipitating oily particles from the gas flow of the crankcase ventilation of an internal combustion engine. The efficiency of such an electrostatic precipitator decreases and the risk of electrical breakdowns that may possibly destroy the entire component increases, if deposits that accumulate on the collecting electrode are not routinely cleaned off. The cleaning itself can be problematic for several reasons. For example, cleaning may require moving components that are exposed to the vibrations and operating conditions of the internal combustion engine and, thus, are subject to damage. On the other hand, cleaning without the use of moving components requires that a fluid be sprayed onto the collecting electrode, and, in such instances, it is not possible to guarantee that the cleaning is done satisfactorily.

What is needed, therefore, is an inexpensive collecting electrode for an electrostatic precipitator of an internal combustion engine, that will ensure reliable, trouble-free, and effective operation of the electrostatic precipitator for a specified period of time.

### BRIEF SUMMARY OF THE INVENTION

The object of the invention is achieved with a collecting electrode that is replaceable during the course of maintenance work. In other words, the invention proposes that the collecting electrode be routinely changed and, for this purpose, that it be designed as a component that is replaceable during maintenance work. The collecting electrode according to the invention is now designed to guarantee faultless functioning of the precipitator between two regularly scheduled service intervals. This eliminates the need of a technically complex arrangement of mechanically operating cleaning mechanisms that serve to maintain proper functioning of the electrostatic precipitator over its entire service life. The component has a simpler overall configuration, which results in reduced component costs. The collecting electrode according to the invention is designed, for example, as a deep-drawn aluminum casing or sleeve, which is ready to install upon exit from the deep-draw tool. The electrode no longer has to withstand the stress of mechanical cleaning and, it is no longer necessary to manufacture the electrode as a metal casting part, which possibly also required chip removal. The collecting electrode according to the invention enables simplified design and construction of the part, thus reducing cost and effort in manufacturing the part.

The replaceable collecting electrode is preferably not constructed as an integral part of a housing component that is designed to be a component that lasts for the service life of an internal combustion engine or is permanently connected to such a component, e.g., by welding or adhesion. Although it is true that every component in an internal combustion engine may be replaced, replacing components that are intended to last the service life of the engine typically requires significant effort with regard to time. In order to facilitate economic replaceability, the inventive electrode is expressly designed as a part that is “replaceable during maintenance work,” and is made to be so readily accessible to be replaced as easily and quickly as spark plugs or light bulbs, or an oil filter insert.

The collecting electrode may be constructed as a metal component, so that it has the required conductivity of an electrode. Advantageously, however, the collecting electrode according to the invention may be made of plastic, thus creating a component that is especially lightweight and also very inexpensive to produce and replace. The conductivity required for the electrode may be provided by an additive on the collecting electrode. Such an additive may, for example, be provided as a conductive surface layer on the electrode, for example, by vapor-coating the existing plastic electrode body with metal. Alternatively or in addition, the conductivity-improving additive may be mixed into the plastic material of the collecting electrode, such that it is distributed through the plastic. Carbon or other commercially available additive may be used as the additive.

Alternatively or also in addition to the above, the conductivity-improving additive may be provided as a thin-walled, conductive, independent casing that is so thin that it is considered to be both inexpensive and lightweight and that the collecting electrode body made of plastic serves as a support for this thin casing. In this case, the casing may be made of metallic or other conductive foil. Depending on the shape of the electrode, an adhesive agent may be co-extruded or added to the extrusion process when making the plastic electrode body, as a means for attaching the casing to the body.

Advantageously, the collecting electrode may be accessible through an assembly aperture and the electrode component itself include a cap or closing member that closes this assembly aperture. The assembly aperture is made accessible by loosening the closing member. Removing the closing member or stopper simultaneously removes the collecting electrode from the electrostatic precipitator. An example of a suitable closing member is, for example, a screw cap.

Advantageously, the closing member may be provided with a manipulator or gripper that serves to simultaneously manipulate both the collecting electrode and the closing member. Thus, instead of having a spanner flat that can be grabbed by a tool, the closing member may be in the form of a gripper that can be gripped and operated by hand, thus facilitating particularly quick replacement of the collecting electrode, without requiring the use of a tool.

Advantageously, a rotational flow device may be provided in the inflow area of the collecting electrode, so that gas flowing into the electrostatic precipitator has a rotational flow. The rotational flow exerts a centrifugal force on particles in the flow, causing them to precipitate out of the gas flow. The rotational flow effects a continuous moistening of the collecting electrode and, thus, a cleaning or washing off of the deposited contaminants, or prevents contaminants that are difficult to remove from being deposited on the collecting electrode in the first place. In either case, the rotational gas flow extends the functionality of the electrode.

Advantageously, the collecting electrode may be designed essentially as a tube, so that it may be used in conventional electrostatic precipitators in which a pin-shaped emission electrode extends into the inside of this tubular collecting electrode. In particular, the emission electrode may be designed as a two stage electrode, a first part having a small diameter, which, for example, serves to form a corona, and a second part with a larger diameter in the flow area of the gas, in which the deposit occurs on the collecting electrode.

Advantageously, the collecting electrode may be designed as a part of the oil feed tube of an internal combustion engine. No additional assembly or maintenance hole is required with this construction. Rather, particularly when space is tight, for example, in the engine compartment of an automobile, the collecting electrode is accessible via the assembly aperture, which, as the oil-filler cap, also simultaneously enables filling oil into the internal combustion engine.

When the collecting electrode is used in an electrostatic precipitator for oil precipitation, for example, in the crankcase ventilation of an internal combustion engine, the electrostatic precipitator may advantageously be disposed in the cylinder-head cover of the internal combustion engine. This enables easy accessibility to the electrostatic precipitator, which facilitates quick and particularly economic replaceability of the collecting electrode.

### BRIEF DESCRIPTION OF THE DRAWINGS

The present invention is described with reference to the accompanying drawings. In the drawings, like reference numbers indicate identical or functionally similar elements.

FIG. 1 is a vertical cross-sectional view of the electrostatic precipitator.

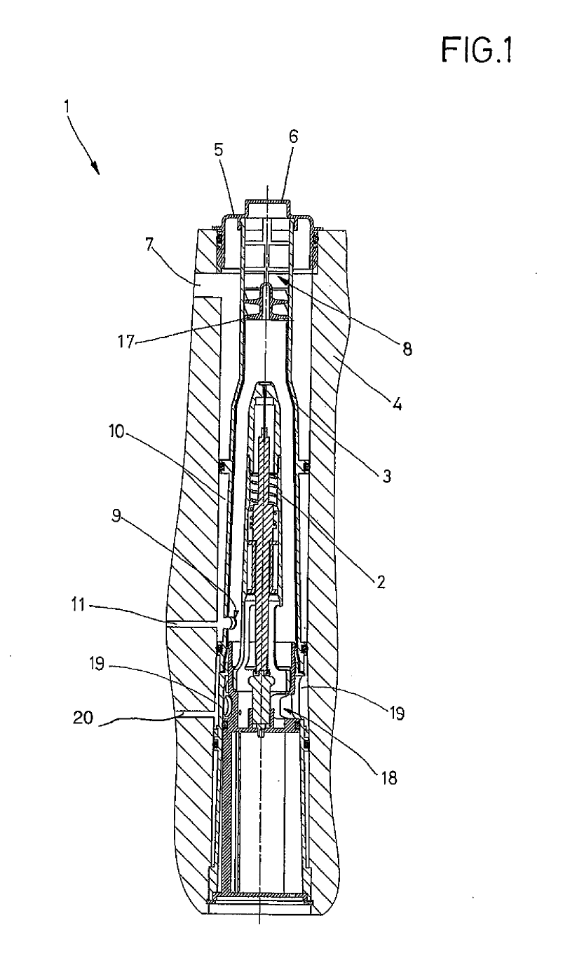

FIG. 2 illustrates a first embodiment of a collecting electrode.

FIG. 3 illustrates a second embodiment of a collecting electrode.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

In the drawings, reference designation 1 refers generally to an electrostatic precipitator according to the invention, comprising an emission electrode 2 and a collecting electrode 3. The electrostatic precipitator 1 is assembled in a component 4 that is part of an internal combustion engine or part of an auxiliary component of the internal combustion engine, such as a cover for the cylinder head or an oil-feed duct. The collecting electrode 3 is connected to a closing member 5 that has a spanner flat 6, which enables the closing member 5, along with the collecting electrode 3, to be removed form the electrostatic precipitator 1.

Gas that is charged or loaded with oil particles reaches the inside of the somewhat tubular collecting electrode 3 through an inlet 7 and an inlet grate 8. Before the gas reaches the operational sphere of the emission electrode 2, it is forced into rotational flow by a twisting device 17. This imparts a centrifugal force on the flow and causes coarse particles to precipitate out of the gas. This rotational flow has two advantages: it improves the efficiency of the electrostatic precipitator, and secondly, by moistening the surface of the collecting electrode 3, prevents the deposit of hard-to-remove electrically precipitated particles onto the collecting electrode 3.

The electrostatic precipitator 1 is intended for horizontal installation. Precipitated particles collect on the lower periphery of the collecting electrode 3, reach a collection chamber 10 through an outlet 9, and from there exit the electrostatic precipitator 1 through an outlet duct 11.

Passing the emission electrode 2, the purified air reaches an area of the electrostatic precipitator 1 that lies downstream of the collecting electrode 3 in the flow direction. There, moving radially toward the outside, it passes through an outlet window 18 into an annular space 19, which is sealed axially on both ends. The air leaves the electrostatic precipitator 1 through an air outlet duct 20.

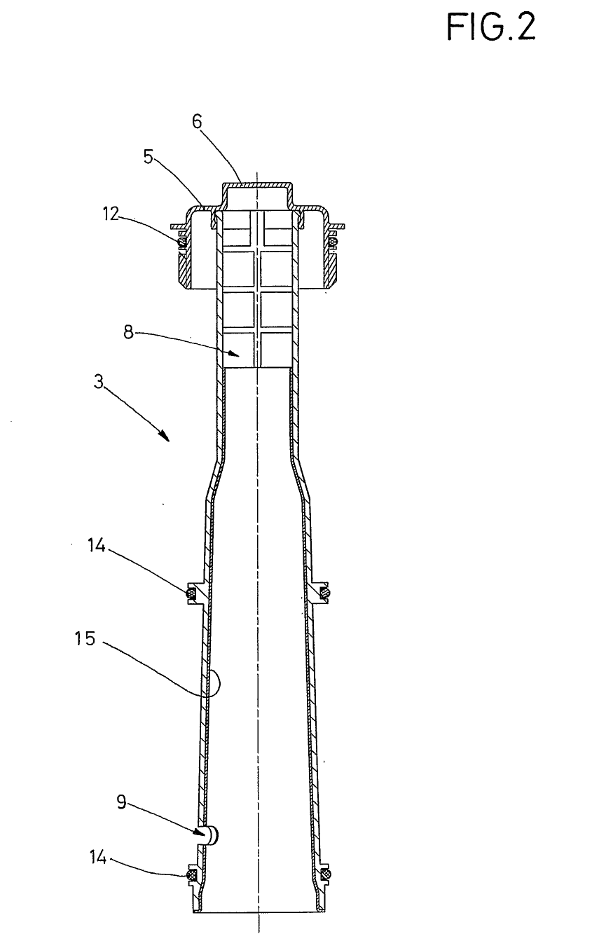

FIG. 2 shows a collecting electrode 3 with the attached closing member 5 and its spanner flat 6. An O-ring gasket 12 is provided in the area of the closing member 5, and two comparable seals 14 are also provided along the additional length of the collecting electrode 3.

The collecting electrode 3 is essentially made of plastic, but in the flow direction of the gas downstream of the inlet grating 8, it has an additive 15, which, for example, may be produced as an independent metallic casing that is so thin that, for the sake of insufficient mechanical stability, the additive 15 is supported by the external plastic wall of the collecting electrode 3. The additive 15, however, may also be a surface coating on an existing plastic collecting electrode 3, for example, applied as a vapor-coating of conductive material or as a galvanic coating.

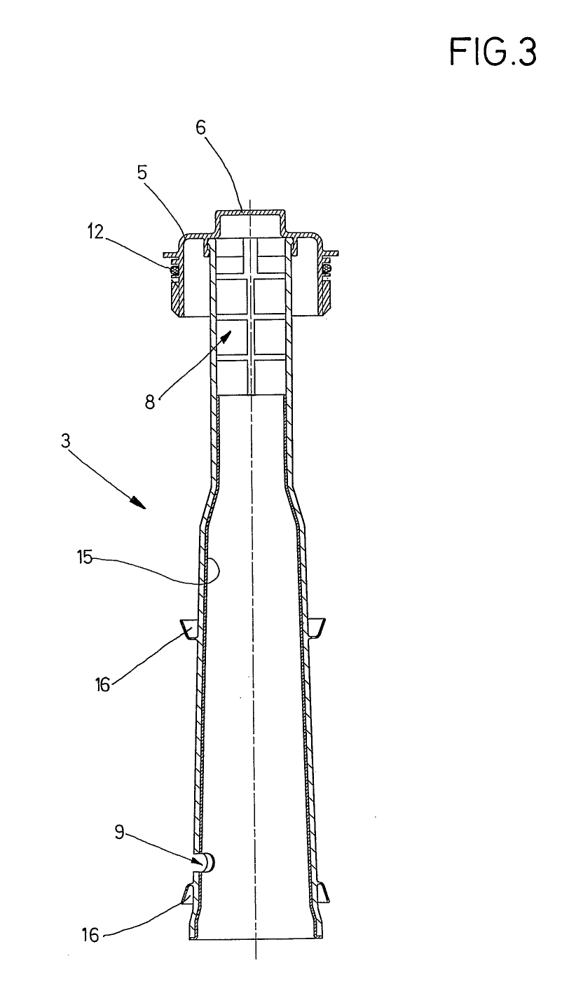

FIG. 3 illustrates a second embodiment of the collecting electrode 3, similar to the embodiment shown in FIG. 2, wherein, however, fitted sealing flanges 16 are provided on the collecting electrode 3 shown in FIG. 3, instead of the two O-ring gaskets 14. The use of the flanges 16 in place of O-rings has several advantages: they reduce the cost of production of the collecting electrode 3, because the relatively expensive elastomeric materials for gaskets are not needed, but also reduce the cost of assembly, because the flanges 16 are made of the same material as the walls of the collecting electrode 3. The sealing flanges 16 have relatively thin walls, which allows them to deform sufficiently to provide an air-tight seal against the component 4 that surrounds the collecting electrode 3.

It is understood that the embodiments described herein are merely illustrative of the present invention. Variations in the construction of the electrostatic precipitator may be contemplated by one skilled in the art without limiting the intended scope of the invention herein disclosed and as defined by the following claims.

What is claimed is:

1-15. (canceled)

16. A collecting electrode for use in an electrostatic precipitator in an internal combustion engine, said collecting electrode being a replaceable component that is easily insertable into and removable from an aperture that is provided in said internal combustion engine, as a routine maintenance task.

17. The collecting electrode of claim 16, said collecting electrode having a plastic body and an additive that provides said plastic body with electrical conductivity.

18. The collecting electrode of claim 17, wherein said additive is a conductive coating on said plastic body.

19. The collecting electrode of claim 17, wherein said additive is a thin-walled conductive casing that lines said plastic body.

20. The collecting electrode of claim 17, wherein said additive is a conductive material that is added to and distributed throughout a plastic material that is used to form said plastic body.

21. The collecting electrode of claim 16, further comprising a closing member that is adapted for closing said aperture;
wherein said collecting electrode has a first end that is integrated into said closing member, and wherein said collecting electrode and said closing member provide a replaceable collecting electrode that is removable from said electrostatic precipitator by removing said closing member from said aperture and insertable into said electrostatic precipitator by fastening said closing member to said aperture.

22. The collecting electrode of claim 16, wherein said closing member is a screw cap that threads into said aperture.

23. The collecting electrode of claim 16, wherein said closing member has a gripping means for manually attaching and detaching said closing member to said aperture.

24. The collecting electrode of claim 16 further comprising a rotational flow device that is provided in an inflow area of said collecting electrode.

25. The collecting electrode of claim 16, wherein said collecting electrode is tubular in shape.

26. The collecting electrode of claim of claim 25, wherein said collecting electrode is constructed as part of an oil-feed duct in said internal combustion engine.

27. The collecting electrode assembly of claim 16, said collecting electrode having an electrode wall, and said electrode further comprising a circular sealing flange that is formed as an integral part of said electrode wall.

28. An internal combustion engine comprising:
an electrostatic precipitator provided in a component of said internal combustion engine, said component having an aperture that provides access to said electrostatic precipitator and that is readily accessible for maintenance work; and
a replaceable collecting electrode that is easily insertable into said electrostatic precipitator as a routine maintenance task.

29. The internal combustion engine of claim 28, wherein said component is an oil-feed duct and said electrostatic precipitator is provided in said oil-feed duct.

30. The internal combustion engine of claim 28, wherein said component is a crankcase ventilation component and said electrostatic precipitator is an oil-mist precipitator that is provided in the crankcase ventilation.

31. The internal combustion engine of claim 27, wherein said component is a cylinder head cover and said electrostatic precipitator is disposed in said cylinder head cover.

32. An electrostatic precipitator for an internal combustion engine, said electrostatic precipitator comprising:
a replaceable collecting electrode; and
an emission electrode;
wherein said replaceable collecting electrode is a replaceable component that is easily insertable into and removable from said electrostatic precipitator, as a routine maintenance task.

33. The electrostatic precipitator of claim 32, wherein said replaceable collecting electrode has a plastic body and an additive that provides said plastic body with electrical conductivity.

34. The electrostatic precipitator of claim 33, wherein said additive is a conductive coating on said plastic body.

35. The electrostatic precipitator of claim 33, wherein said additive is a thin-walled conductive casing that lines said plastic body.

36. The electrostatic precipitator of claim 33, wherein said additive is a conductive material that is added to and distributed throughout a plastic material that is used to form said plastic body.

37. The electrostatic precipitator of claim 16, further comprising a closing member that is adapted for closing said aperture;
wherein said replaceable collecting electrode has a first end that is integrated into said closing member, and wherein said replaceable collecting electrode and said closing member provide replaceable component that is removable from said electrostatic precipitator by removing said closing member from said aperture and insertable into said electrostatic precipitator by fastening said closing member to said aperture.
